(19) United States
(12) Patent Application Publication
(10) Pub. No.: US 2004/0266305 A1
(43) Pub. Date: Dec. 30, 2004

(54) Packaging laminate and a packaging container produced therefrom

(76) Inventors: Lars Bergholtz, Hoganas (SE); Hans Johansson, Lomma (SE)

Correspondence Address: BURNS DOANE SWECKER & MATHIS L L P, POST OFFICE BOX 1404, ALEXANDRIA, VA, 22313-1404, US

(21) Appl. No.: 10/490,997

(22) PCT Filed: Oct. 2, 2002
(86) PCT No.: PCT/SE02/01792

(30) Foreign Application Priority Data
Oct. 4, 2001 (SE) 0103308-3

(51) Int. Cl. B32B 27/12

(52) U.S. Cl. 442/394; 156/217

(57) ABSTRACT

The disclosure relates to a packaging laminate including a rigidifying core which comprises two rigid outer layers of which one of these two layers consists of a layer of mineral-filled polyolefin, as well as a bulking layer disposed between the above mentioned two rigid outer layers. According to the present invention, the bulking layer consists of a non-woven material. The present invention also relates to a packaging container preferably for liquid foods which is produced by fold forming and sealing of the sheet or web-shaped packaging laminate.

### FIELD OF THE INVENTION

Generally speaking, the present invention relates to the fields of digital communication, digital image processing and image-capturing hand-held devices. More specifically, the present invention concerns an optical sensor device having an illuminating light source and an image sensor, wherein the image sensor is adapted to capture a sequence of images under exposure of light from the light source. The invention also concerns a method of controlling the exposure time of such an optical sensor device.

### BACKGROUND OF THE INVENTION

Image-capturing hand-held devices of the above type are widely used. For instance, a digital pen is shown in Applicant's published international application WO 01/16691, which is incorporated herein by reference. As described in WO 01/16691, the digital pen may be used together with a product which has a writing surface and a position code provided thereon. The position code encodes a plurality of positions on the surface and may be detected by the digital pen. Thus, information which is being written on the writing surface by means of the digital pen can be electronically recorded by the pen.

In a position-coding product of the above or other types, the code is often represented by a graphical pattern of geometrical objects, marks or symbols, such as empty or filled circles (dots), squares, triangles, etc. The symbols may have uniform or varying appearance (size, color, etc), depending on the actual position coding principle involved. The surface of the product is pro-A packaging laminate and a packaging container produced therefrom

### TECHNICAL FIELD

The present invention relates to a packaging laminate comprising a rigidifying core which consists of two rigid outer layers, of which one of these two layers consists of a layer of mineral-filled polyolefin, as well as a bulking layer disposed between said two rigid outer layers. The present invention also relates to a packaging container produced from the packaging laminate and intended for food, preferably liquid food.

### BACKGROUND ART

Nowadays, liquid foods are packed and transported most generally in packaging containers of the single-use disposable type, and a very large group of these so-called single-use packages is produced from a packaging laminate consisting of a core layer of paper or paperboard and outer coatings of a thermoplastic, normally polyethylene. Well-known examples of such commercial single-use packages of those which are marketed under the registered trademarks TETRA BRIK, TETRA REX and TETRA TOP.

Packaging layers produced from a packaging laminate which only consists of paper or paperboard layers and outer coatings of polyethylene are per se sufficiently mechanically strong and stable to withstand outer stresses in normal transport and handling. However, in many cases it would be desirable to replace the paper or paperboard layer with polymer material. For example, it would be desirable to utilise a mineral-filled polyolefin material since this affords technical and economic advantages such as superior printability, good resistance to moisture and superior economics, which constitute advantages in connection with the production of packaging containers, in particular for liquid foods. However, seen from the viewpoint of attained flexural rigidity per cost unit, mineral-filled polyolefin material cannot compete with paperboard. For this reason, use is made today of mineral-filled polyolefin material only for packaging containers of a less configurationally rigid nature. However, replacing the paperboard layer in configurationally rigid packaging containers only by a mineral-filled polyolefin material with retained flexural rigidity would not be economically viable.

SE 0003399-3 and SE 0003400-9 constitute examples of patent applications which disclose packaging laminates consisting of layers of mineral-filled polyolefin material, as well as core layers of paper, paperboard or plastic material.

A material is known from SE 8802777-6 for conversion into configurationally rigid packaging containers, the material including a rigidifying core consisting of core layers of mineral-filled thermoplastic which are laminated to one another and which, according to one embodiment, may be united to one another by the intermediary of an interjacent bulking layer of foamed polypropylene-homopolymer. Problems may, however, arise in this type of laminate in causing the foamed layer to retain its bulking nature, in which event the foamed layer wholly or partly collapses and thereby loses its bulking nature which in turn results in the laminate losing flexural rigidity. Further, there is a disadvantage inherent in the laminate of the type described in SE 8802777-6 that mechanical properties such as tensile strength are relatively poor in the core layer in comparison with the core layer of paper or paperboard.

There is thus still a need in the art for an improved packaging laminate of the type described by way of introduction, and one object of the present invention is therefore to provide an indication as to how the described problem in attaining a rigidifying core which consists of two rigid outer layers, of which one of these layers consists of a layer of mineral-filled polyolefin, as well as a bulking layer disposed between said two rigid outer layers, but substantially no paper or paperboard layer, the core displaying superior mechanical properties and being stable in its bulking nature, in such a packaging laminate, may effectively and readily be solved without attendant problems and drawbacks which are related to the previously proposed solutions.

It is also desirable in the art to offer a packaging laminate of the type described by way of introduction which displays a rigidifying core which is suitable for coating and/or laminating of/together with other layers in the laminate.

These and other objects and advantages will be attained according to the present invention by means of a packaging laminate according to independent claim 1 and by means of a packaging container according to independent claim 15 which is produced from the packaging laminate according to the present invention. Expedient practical embodiments of the packaging laminate according to the present invention have further been given the characterising features as set forth in appended subclaims 2-14.

### SUMMARY OF THE INVENTION

According to the present invention, there will thus be provided a packaging laminate consisting of a rigidifying core which consists of two rigid outer layers, of which one of these two layers consists of a layer of mineral-filled polyolefin, as well as a bulking layer disposed between said two rigid outer layers, the bulking layer consisting of a non-woven material.

According to one aspect of the present invention, the bulking non-woven layer should display a density of 100-350 kg/m³, preferably 150-300 kg/m³, counting as surface weight/thickness of the layer.

In order that the non-woven layer give the desired bulking effect and thereby display the desired low density, the interspaces between the fibres in the non-woven material are substantially unfilled, i.e. they consist substantially of air and are not filled with, for example, polymer or other material. Only in the outer surfaces of the non-woven layer facing towards surrounding layers may it occur that the interspaces are filled with glue or other adhesive or polymer material, e.g. from adjacent layers, the polymer material having melted or softened and filled the interspaces in connection with the lamination process.

According to another aspect of the present invention, it is preferred that said non-woven material be built up of thermoplastic fibres, e.g. polypropylene, polyethylene or polyethylene terephthalate, it being preferred that the non-woven material consists of so-called melt bond or spun bond non-woven or combinations thereof. However, it is also fully possible to attain the principle according to the present invention utilising non-woven material of other types of synthetic, continuously formed fibres.

According to yet a further aspect of the present invention, the relationship in surface weight between the mineral-filled polyolefin layer and the bulking layer is 1:0.5-1:5, preferably 1:1-1:3 and even more preferably 1:1.5-1:2.5.

Together, the bulking layer and the mineral-filled polyolefin layer give a grammage or surface weight of 100-350 g/m², preferably 150-300 g/m². For portion packages of a volume of 350 ml or less, the total surface weight of the bulking layer and the mineral-filled polyolefin layer is suitably 150-250 g/m². For family packages of a volume of about 1000 ml, the total surface weight of the bulking layer and the mineral-filled polyolefin layer is suitably 200-300 g/m².

In total, the packaging laminate according to the present invention displays a surface weight of preferably 200-450 g/m² and even more preferably 250-400 g/m².

A suitable mineral-filled polyolefin layer for employment together with the bulking layer in the core for the packaging laminate according to the present invention is easy to produce using already existing equipment in this area, and has, in comparison with corresponding layers of pure or unfilled poloylefin, advantageously lower permeability speeds for moisture. A mineral-filled polyolefin layer also displays a lower material cost per kilogram than a corresponding layer of pure or unfilled polyolefin. Moreover, a mineral-filled polyolefin layer per se possesses a certain material rigidity which advantageously contributes in imparting increased flexural rigidity to the packaging laminate.

A suitable mineral-filled polyolefin layer for use in the packaging laminate according to the present invention includes a matrix of polyolefin with admixed inorganic mineral particles in quantities which in general lie within the range of from 5 to 85% of the total weight of the mineral-filled polyolefin layer. If the packaging laminate is intended to pack, for example, particularly oxygen-gas sensitive liquid foods such as juice and wine, or if the packaging laminate is to be employed for packing liquid foods possessing so-called extended shelf-life, the second rigidifying layer in the core suitably consists of aluminium foil. Alternatively, the second rigidifying layer may consist of a second layer of mineral-filled poloylefin plus a layer of a gas barrier material, e.g. EVOH.

Examples of usable inorganic material particles for use in the present invention are particles selected from the group which essentially consists of dolomite, talcum, chalk, mica, limestone, marble, kaolin and wollastonite. Preferably, the inorganic mineral particles are a mixture of talcum particles and dolomite or limestone particles in which the quantity of dolomite or limestone particles is between 5 and 90% and the quantity of talcum particles is between 10 and 50%, calculated on the total weight of the mixture. It is, however, possible to utilise up to 100% talcum particles.

Preferably, the matrix of the mineral-filled polyolefin layer consists of a propylene based polyolefin, such as, for example, a polypropylene homopolymer or a polypropylene copolymer with comonomer ethylene and/or other alkene. Preferably, the propylene based polyolefin is a polypropylene homopolymer with an ASTM melt index of under 10 (2.16 kg; 230° C.) or a polypropylene copolymer with comonomer ethylene and/or other alkene with an ASTM melt index of 0.5-5 (2.16 kg; 230° C.).

Between the bulking layer of non-woven material and the mineral-filled polyolefin layer, use may possibly be made of an interjacent polymer laminating layer, glue or other adhesive, but it may also be the case that the two layers are directly united to one another throughout substantially all of their mutually facing surfaces, e.g. in that the non-woven layer is united with a recently extruded and, consequently, still molten/soft layer of mineral-filled polyolefin.

On the one side of the core opposite to that side on which the first rigid outer layer which consists of a mineral-filled polyolefin layer is, possibly with an interjacent polymer lamination layer, glue or other adhesive, the second rigid outer layer of the core is disposed, which, together with the mineral-filled polyolefin layer and the bulking non-woven layer, gives a rigidifying I beam effect in the core. This second layer preferably consists of a layer of aluminium foil which also functions as a barrier layer, principally against gases (oxygen-gas), or a second layer of mineral-filled polyolefin of a composition according to that described above in connection with the layer according to the present invention of mineral-filled polyolefin, preferably together with an oxygen-gas barrier layer of thermoplastic, e.g. EVOH. This second, rigid outer layer should, according to the present invention, display an E-modulus greater than 2000 MPa in MD (the machine direction).

The packaging laminate preferably displays outer, liquid-tight coatings of thermoplastic on both outer sides of the core layer, which render the packaging laminate sealable by so-called thermosealing which is a simple, but efficient sealing technique for achieving mechanically strong and liquid-tight sealing joints or seams when the packaging laminate is reformed into packaging containers. Preferably, the outer, liquid-tight coatings consist of polyethylene, which may be polymerised with so-called free radical technique: low density polyethylene (LDPE); or with catalyst technique: high density polyethylene (HDPE), medium density polyethylene (MDPE), linear low density polyethylene (LLDPE), polyethylene of very low density (VLDPE), polyethylene of ultra low density (ULDPE) or metallocene/single site catalyst PE (mPE).

Thanks to the described structure of the packaging laminate according to the present invention, a number of advantages will be attained. The mineral-filled polyolefin layer/layers afford technical and economical advantages such as flexural. rigidity, superior printability properties, resistance to moisture and low cost. The bulking non-woven layer functions as a spacer element in accordance with the I beam principle which gives superior flexural rigidity. At the same time, the fibres in the non-woven material contribute to the tensile strength of the laminate. Further, the rigidifying core according to the present invention is suitable for coating and/or laminating of/together with other layers which are desired in the packaging laminate. Trials have demonstrated that a core according to the present invention can replace a core layer of paper or paperboard with retained or improved flexural rigidity at lower cost and lower total surface weight of the packaging laminate.

### BRIEF DESCRIPTION OF THE ACCOMPANYING DRAWINGS

The present invention will now be described and explained in greater detail hereinbelow with the aid of non-restrictive embodiments and with reference to the accompanying drawings in which:

FIG. 1 schematically shows a cross section of a first packaging laminate according to the present invention;

FIG. 2 schematically shows a cross section of a second packaging laminate according to the present invention; and

FIG. 3 schematically shows a cross section of a third packaging laminate according to the present invention.

### DETAILED DESCRIPTION OF EMBODIMENTS

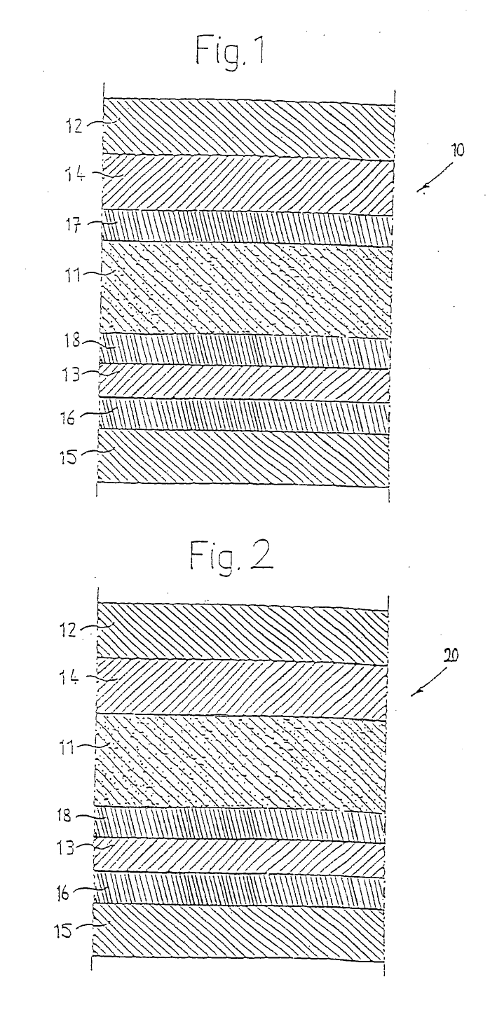

FIG. 1 schematically shows a cross section of a first packaging laminate according to the present invention. The packaging laminate carrying the generic reference numeral 10 includes a rigid but foldable core which, according to the present invention, includes a layer 14 of mineral-filled polyolefin, a bulking layer 11 of non-woven material (e.g. polypropylene) as well as a second rigid layer 13 disposed on the opposite side of the bulking layer, i.e. opposed to the layer 14. This second, rigid layer 13 may advantageously consist of a gas barrier layer, preferably of aluminium foil, or a second layer of mineral-filled polyolefin. The core 14, 11 and 13 form together a structure which acts to increase flexural rigidity in accordance with the I beam principle.

The packaging laminate further includes outer, liquid-tight coatings 12 and 15 of thermoplastic, in accordance with the foregoing. The outer layer 15 constitutes that layer which will be in contact with the contents of the package, usually the liquid food, in the package which is fold-formed from the laminate. Between the barrier layer 13 and the outer thermoplastic layer 15, there is disposed a layer 16 of suitable binder/adhesive, for example ethylene acrylic acid-copolymer or PE.

The packaging laminate illustrated in FIG. 1 is produced by a lamination process in which a prefabricated film, possibly provided with print, of mineral-filled polyolefin (the layer 14 of the packaging laminate 10) is laminated and permanently united to one side of a web of non-woven material (the bulking layer 11 of the packaging laminate 10). Superior and permanent bonding strength between the prefabricated film and the bulking layer is ensured by a film of suitable binder of, for example, polypropylene or polyethylene, which forms a binder layer 17 which is extruded simultaneously between the bulking layer 11 and the film which forms the layer 14.

In the same or in another lamination step, the thus formed multi layer structure 14, 17, 11 including the bulking layer is laminated together and permanently united to the barrier layer 13 (i.e. the second, rigid outer layer). Superior and permanent bonding strength is ensured by a film of suitable binder which forms a binder layer 18 which is extruded simultaneously between the bulking layer 11 and the barrier layer 13.

The outer thermoplastic layers 12, 15, including the layer 16, can be applied in principle at any time whatever, but suitably once the remaining layers have been joined together in accordance with the foregoing. It is also conceivable to provide the layer 14 with printed matter in another stage during the production process, but before the thermoplastic 12 is applied.

FIG. 2 schematically illustrates a cross section of a second packaging laminate according to the invention. The packaging laminate carrying the generic reference numeral 20 includes the same layers as the packaging laminate 10 in FIG. 1, with the exception of the binder layer 17. The reason for this is that, in this embodiment, the mineral-filled polyolefin layer 14 has instead been laid direct on the bulking non-woven layer 11, in that a web of the non-woven material has been coated with a film of mineral-filled polyolefin (the layer 14 of the packaging laminate 20).

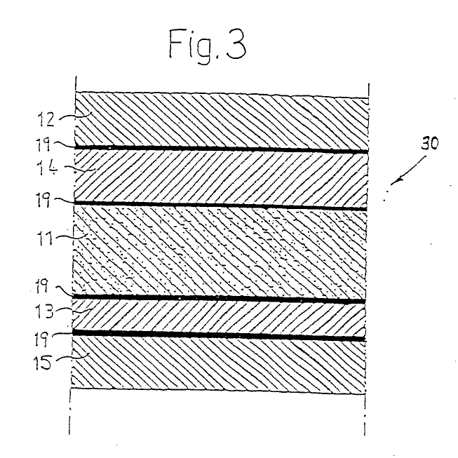

FIG. 3 schematically shows a cross section of a third packaging laminate according to the present invention. The packaging laminate carrying the generic reference numeral 30 includes, like the packaging laminates 10 and 20 in FIGS. 1 and 2, respectively, a mineral-filled polyolefin layer 14, a bulking layer 11 of non-woven material, a barrier layer 13 and two outer, liquid-tight and thermosealable layers 12, 15 of thermoplastic. In this embodiment, these different layers have, however, been laid together and permanently united with the aid of a glue layer 19, preferably a setting glue layer, e.g. polyurethane glue or a thermoplastic glue layer, e.g. amorphous poly alfa olefin APAO, i.e. non crystalline copolymers.

From the packaging laminate according to the present invention, dimensionally stable packaging containers are produced in a per se known manner with the aid of modern filling machines of the type which, from a web or from prefabricated sheets of the packaging laminate, form, fill and seal finished packages according to the so-called form/fill/seal technique.

From, for example, a web, packaging containers are produced in that the web is first reformed into a tube by both longitudinal edges of the web being united with each other in liquid-tight overlap seal with the packaging laminate placed on that side of the core layer which is turned to face inwards in the tube. The tube is filled with the relevant contents, e.g. juice, and is divided by repeated transverse seals into individual cushion-shaped packaging units which are separated from one another by incisions in the transverse sealing zones. By a subsequent forming and sealing operation, the cushion-shaped packaging units are thereafter given their final geometric, normally parallelepipedic, configuration.

A packaging container produced from a packaging laminate according to the invention has sufficiently good tightness properties vis-à-vis both liquids and gases in order to make for a lengthy and reliable storage of even particularly perishable foods of the type such as juice, wine and cooking oil.

It will thus have been apparent from the foregoing description that the present invention, in a simple manner and by simple means, attains the established objects. While the detailed description of the present invention, in connection with the accompanying drawings, refers to specific embodiments, the present invention is naturally not restricted exclusively to them. It will be obvious to a person skilled in the art that many alterations and modifications are possible without departing from the invented concept as this is defined in the appended claims.

1. A packaging laminate consisting of a rigidifying core which includes two rigid outer layers, of which one of these two layers consists of a layer of mineral-filled polyolefin, as well as a bulking layer disposed between said two rigid outer layers, wherein the bulking layer consists of non-woven material.

2. The packaging laminate as claimed in claim 1, wherein said bulking non-woven layer displays a density of 100-350 kg/m³, preferably 150-300 kg/m³, counted as surface weight/thickness.

3. The packaging laminate as claimed in claim 1 wherein said non-woven material is built up from thermoplastic fibres, preferably of polypropylene, polyethylene or polyethylene terephthalate, it being preferred that the non-woven material consists of so-called melt bond or spun bond non-woven, or combinations thereof.

4. The packaging laminate as claimed in claim 1, wherein a relationship in surface weight between the mineral-filled polyolefin layer and the bulking layer is 1:0.5-1:5, preferably 1:1-1:3 and even more preferably 1:1.5-1:2.5, the bulking layer and the mineral-filled polyolefin layer together displaying a surface weight of preferably 100-350 g/m², preferably 150-300 g/m².

5. The packaging laminate as claimed in claim 1, wherein the mineral-filled polyolefin layer includes inorganic mineral particles in a quantity from 5 to 85%, preferably from 50 to 85%, of its total weight.

6. The packaging laminate as claimed in claim 1, wherein the inorganic mineral particles are selected from the group essentially comprising dolomite, talcum, chalk, mica, limestone, marble, kaolin and wollastonite, and preferably consist of a mixture of talcum particles and dolomite or calcium particles.

7. The packaging laminate as claimed in claim 1, wherein the mineral-filled polyolefin layer includes a polyolefin which is selected from the group essentially comprising polypropylene based polyolefins.

8. The packaging laminate as claimed in claim 7, wherein the polypropylene based polyolefin is a polypropylene homopolymer or a polypropylene copolymer with comonomer ethylene and/or other alkene.

9. The packaging laminate as claimed in claim 1, wherein it includes outer coatings of thermosealable plastic on both sides of the core, the thermosealable plastic including polyethylene, preferably selected from the group essentially comprising high density polyethylene (HDPE), medium density polyethylene (MDPE), low density polyethylene (LDPE), linear low density polyethylene (LLDPE), polyethylene of very low density (VLDPE), polyethylene of ultra low density (ULDPE) or metallocene/single site catalyst PE (mPE).

10. The packaging laminate as claimed in claim 1, wherein the second of said two rigid outer layers displays an E modulus greater than 2000 MPa in its machine direction.

11. The packaging laminate as claimed in claim 1, wherein the second of said two rigid outer layers consists of a barrier layer, said barrier layer preferably including a layer of aluminium foil and/or a second layer of mineral-filled polyolefin and/or a layer of thermoplastic gas barrier material.

12. The packaging laminate as claimed in claim 1, wherein said layer of mineral-filled polyolefin is coated on said bulking layer.

13. The packaging laminate as claimed in claim 1, wherein said layer of mineral-filled polyolefin is laminated to said bulking layer by means of an interjacent lamination layer.

14. The packaging laminate as claimed in claim 1, wherein said layer of mineral-filled polyolefin is united with said bulking layer by means of a glue layer, preferably a setting glue layer or a thermoplastic glue layer.

15. A packaging container, preferably for liquid foods, wherein it is produced by fold forming and sealing of a sheet or web-shaped packaging laminate as claimed in claim 1.
